(19) United States
(12) Patent Application Publication
(10) Pub. No.: US 2006/0056870 A1
(43) Pub. Date: Mar. 16, 2006

(54) Image forming apparatus and temperature control method for fixing device

(75) Inventor: Masaaki Oyaide, Tagata-gun (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/939,521

(22) Filed: Sep. 14, 2004

(51) Int. Cl. G03G 15/20

(52) U.S. Cl. 399/69; 399/70

(57) ABSTRACT

At a time of start of a heater alternate turn-on control, if a main heater detection temperature by a main thermistor is higher than a MAIN target temperature tmh and a sub-heater detection temperature by a sub-thermistor is lower than a SUB target temperature tsh, an engine control unit switches a control object to a sub-heater lamp even within a prescribed time Tmcp of a main heater lamp, outputs a SUB ON signal [1] to a driver, and turns on the sub-heater lamp.

### BACKGROUND OF THE INVENTION

The present invention relates to an image forming apparatus such as an electrophotographic copying machine or a laser printer, and to a temperature control method for a fixing device that fixes a toner image on paper in the image forming apparatus.

In a conventional image forming apparatus, a roller-fixation type fixing device with a heating roller is used.

Jpn. Pat. Appln. KOKAI Publication No. 09-325644, for instance, discloses techniques relating to a fixing device control apparatus and a heating temperature control method for a fixing device.

According to this control method, a heater is turned off at a standby time. When a detection temperature tth of a thermistor lowers below a heating start temperature tson of a sub-heater, the sub-heater is turned on. Then, if the detection temperature tth reaches a heating stop temperature tsoff, the sub-heater is turned off. If the detection temperature tth lowers below a heating start temperature tmon of a main heater, the main heater is turned on. Subsequently, if the detection temperature tth reaches a heating stop temperature tmoff of the main heater, the main heater is turned off. This process is repeated.

On the other hand, at a printing time, a drive time period and a non-drive time period for each heater are provided within a predetermined short cycle, and the order of these drive time periods is switched in every cycle, thereby executing a temperature control.

Specifically, at the standby time, the main heater and sub-heater are alternately and individually compared with a control temperature and on/off controlled. At the printing time, the drive time period and the non-drive time period are determined and the main heater and sub-heater are alternately on/off controlled.

In this control, however, at the standby time period, even if the temperature of the sub-heater lowers below a temperature at which abnormal fixation may occur, the sub-heater cannot be turned on until the main heater reaches a target temperature during the on-state of the main heater. The same applies to the reverse case.

In addition, at the printing time, since the heaters are turned on/off at specified times, the control cannot be switched to the heater on the non-control side, even if the heater on the control side reaches the target temperature within the specified time.

Furthermore, if the main heater and sub-heater are controlled based on the temperature detection alone, simultaneous turn-on may occur and power consumption increases. An efficient temperature control cannot be executed.

### BRIEF SUMMARY OF THE INVENTION

The object of an aspect of the present invention is to provide an image forming apparatus and a temperature control method for a fixing device, which can efficiently temperature-control a main heater and a sub-heater.

According to an aspect of the present invention, there is provided an image forming apparatus including a fixing device composed of a first heat roller that is heated by a first heater lamp and a second heat roller that is heated by a second heater lamp, the apparatus comprising: first detection means for detecting a surface temperature of the first heat roller; second detection means for detecting a surface temperature of the second heat roller; and control means for effecting a control to execute simultaneous turn-on of the first and second heater lamps at time of a warm-up operation, to execute alternate turn-on of the first and second heater lamps for a prescribed time at a time of an image forming operation and at a time of a standby operation, and to execute switching of the turned-on heater lamp to the first heater lamp or the second heater lamp even within the prescribed time, in a case where during the alternate turn-on, a detection temperature by the first or second detection means of the first or second heat roller due to heating of the turned-on first or second heater lamp is equal to or higher than a target temperature and a detection temperature by the first or second detection means of the first or second heat roller due to the turned-off first or second heater lamp is equal to or lower than a target temperature.

According to another aspect of the present invention, there is provided a temperature control method for a fixing device composed of a first heat roller that is heated by a first heater lamp and a second heat roller that is heated by a second heater lamp, comprising: detecting a surface temperature nf the first heat roller; detecting a surface temperature of the second heat roller; executing simultaneous turn-on of the first and second heater lamps at time of a warm-up operation; executing alternate turn-on of the first and second heater lamps for a prescribed time at a time of an image forming operation and at a time of a standby operation; and executing switching of the turned-on heater lamp to the first heater lamp or the second heater lamp even within the prescribed time, in a case where during the alternate turn-on, the detected surface temperature of the first or second heat roller due to heating of the turned-on first or second heater lamp is equal to or higher than a target temperature and the detected surface temperature of the first or second heat roller due to the turned-off first or second heater lamp is equal to or lower than a target temperature.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that schematically shows the structure of a control system of a printer section in an image forming apparatus according to the present invention;

FIG. 2 is a cross-sectional view that schematically shows the structure of a fixing device according to the embodiment;

FIG. 3 is a time chart for explaining the temperature control operation of the fixing device; and

FIG. 4 shows a modification of a fixing roller.

### DETAILED DESCRIPTION OF THE INVENTION

An embodiment of the present invention will now be described with reference to the accompanying drawings.

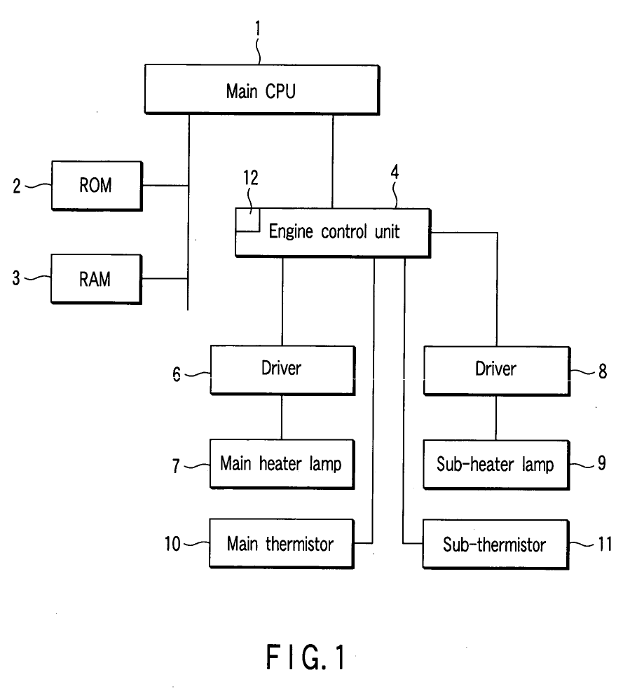

FIG. 1 schematically shows the structure of a control system of a printer section in an image forming apparatus according to the present invention. The control system of the printer section comprises a main CPU 1 that executes an overall control, a ROM 2 that stores a control program, etc., a RAM 3 that temporarily stores data, and an engine control unit 4.

The engine control unit 4 comprises an ASIC. A main heater lamp 7 is connected via a driver 6 to the engine control unit 4. A sub-heater lamp 9 is connected via a driver 8 to the engine control unit 4. In addition, a thermistor 10 and a sub-thermistor 11 are connected to the engine control unit 4.

As will be described later in detail, the engine control unit 4 includes a timer 12 and executes a time control.

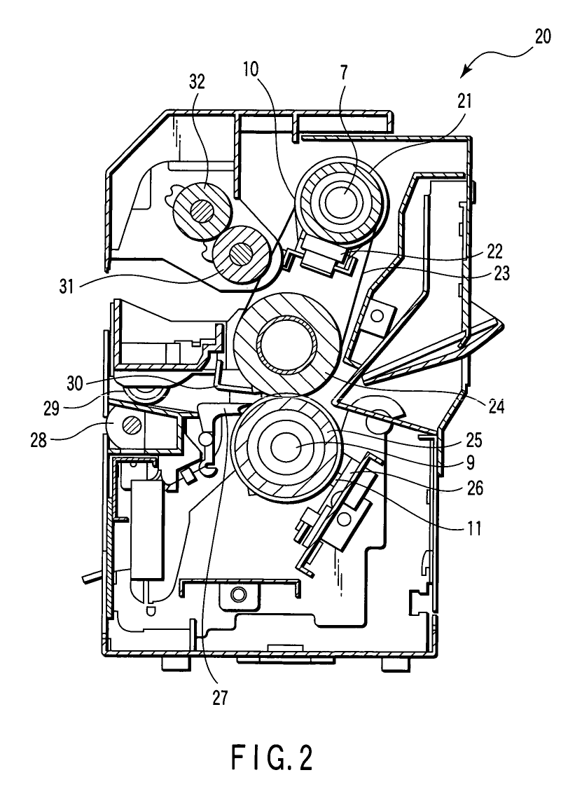

FIG. 2 schematically shows a fixing device 20 according to the embodiment.

The fixing device 20 comprises the aforementioned main heater lamp 7, sub-heater lamp 9, main thermistor 10, sub-thermistor 11, a main heat roller 21, a main thermostat 22, a fixing belt 23, a sub-heat roller 25, a sub-thermostat 26, a separation gripper 27, a lower sheet discharge roller 28, an upper sheet discharge roller 29, a separation guide 30, an oil roller 31, and a cleaning roller 32.

The main heater lamp 7 and sub-heater lamp 9 are divided on the upper and lower sides of a sheet fixing section in the fixing device 20 (i.e. on obverse and reverse sides of paper). The main thermistor 10 and sub-thermistor 11 are disposed at the heater lamps 7 and 9, respectively. A paper sheet, on which toner is not fixed, is inserted from the right side in the Figure. The paper sheet is pressed and heated between toner is fixed on the paper sheet.

The paper sheet, on which the toner is fixed, is separated from the fixing roller 24 and sub-heat roller 25 by the separation guide 30 and separation gripper 27. The sheet is then conveyed to an output unit (not shown; on the left side in FIG. 2) by the upper and lower sheet discharge rollers 28 and 29.

The main thermostat 22 and sub-thermostat 26 for preventing overheat are inserted in series in the heater lamps 7 and 9. In case of abnormal temperatures, the circuit is disconnected.

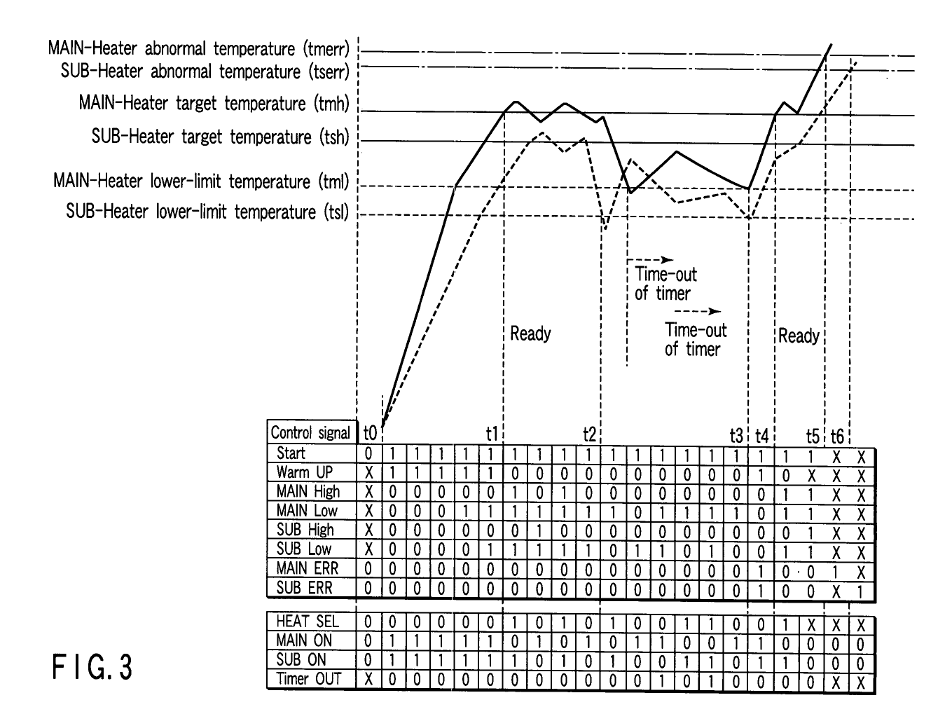

Referring now to a time chart of FIG. 3, a description is given of the temperature control operation of the fixing device 20 with the above-described structure using the main heater lamp 7 and sub-heater lamp 9.

The following six setting temperatures can individually be determined:
Main heater target temperature tmh;
Sub-heater target temperature tsh;
Main heater lower-limit temperature tml;
Sub-heater lower-limit temperature tsl;
Main heater abnormal temperature tmerr; and
Sub-heater abnormal temperature tserr.

The following control signals are used:

Start signal: a signal by which the main CPU 1 instructs the engine control unit 4 to start heating.

Warm UP signal: a signal that is set by the main CPU 1 at a time of Warm UP (i.e. at a time when simultaneous turn-on is possible).

MAIN High signal: a signal that is set at [1] if a temperature detection result of the main heater lamp 7 is a set temperature or above, and is set at [0] if the temperature detection result is less than the set temperature.

MAIN Low signal: a signal that is set at [1] if a temperature detection result of the main heater lamp 7 is a set temperature or above, and is set at [0] if the temperature detection result is less than the set temperature.

SUB High signal: a signal that is set at [1] if a temperature detection result of the sub-heater lamp 9 is a set temperature or above, and is set at [0] if the temperature detection result is less than the set temperature.

SUB Low signal: a signal that is set at [1] if a temperature detection result of the sub-heater lamp 9 is a set temperature or above, and is set at [0] if the temperature detection result is less than the set temperature.

MAIN ERR signal: a signal that is set at [1] if a temperature detection result of the main heater lamp 7 is a set temperature or above, and is set at [0] if the temperature detection result is less than the set temperature.

SUB ERR signal: a signal that is set at [1] if a temperature detection result of the sub-heater lamp 9 is a set temperature or above, and is set at [0] if the temperature detection result is less than the set temperature.

HEAT SEL signal: a heater control switch signal, which designates the main heater lamp 7 by [0] and the sub-heater lamp 9 by [1].

MAIN ON signal: an ON-signal for the main heater lamp 7, which is set at [1] in on-state.

SUB ON signal: an ON-signal for the sub-heater lamp 9, which is set at [1] in on-state.

Timer OUT signal: a signal that is set at [1] if an elapsed time of each heater lamp reaches or exceeds a prescribed time.

By the above setting temperatures and control signals, the fixing device 20 is temperature-controlled in the following manner.

At a warm-up time, a secondary power consumption of a convey motor (not shown), etc. is less than at a printing time. Thus, the main CPU 1 sets the Warm UP signal at [1] for the engine control unit 4.

Upon receiving the Warm UP signal [1], the engine control unit 4 outputs the MAIN ON signal [1] to the driver 6 and turns on the main heater lamp 7. At the same time, the engine control unit 4 outputs the SUB ON signal [1] to the driver 8 and turns on the sub-heater lamp 9, thus starting simultaneous turn-on (t0). This reduces a start-up time. In this embodiment, the heater power consumption at the time of the simultaneous turn-on of the main heater lamp 7 and sub-heater lamp 9 is about 1300 W.

When the main heater detection temperature by the main thermistor 10 becomes equal to or higher than the MAIN target temperature tmh and the sub-heater detection temperature by the sub-thermistor 11 becomes equal to or higher than the SUB lower-limit temperature tsl (or SUB target temperature tsh), the main CPU 1 determines a print-enable state and sets the Warm UP signal at [0] (t1).

Thereby, the heater alternate turn-on control, which characterizes the present invention, is initiated.

In the heater alternate turn-on control, a prescribed time Tmcp for continuous turn-on of the main heater lamp 7 during printing and a prescribed time Tscp for continuous turn-on of the sub-heater lamp 9 during printing are set in advance. The engine control unit 4 activates the timer 12 at turn-on of the main heater lamp 7, and determines whether the prescribed time Tmcp is reached. Similarly, the engine control unit 4 activates the timer 12 at turn-on of the sub-heater lamp 9, and determines whether the prescribed time Tscp is reached.

If the continuous turn-on time from the turn-on of each heater lamp exceeds the prescribed time (Tmcp or Tscp), the engine control unit 4 switches the controlled object to the other heater lamp even in a case where the temperature of the heater lamp does not reach the target value.

The prescribed time is set to be a time (several seconds to ten-odd seconds) enough to reach the target temperature from the lower-limit temperature, in a printing operation using ordinary paper in a normal environment. In addition, the lower-limit temperature is set to be slightly higher (several ° C.) than a temperature at which the deterioration in fixation quality becomes conspicuous when the temperature lowers.

Upon receiving the Start signal [1] from the main CPU 1 (t0), the engine control unit 4 automatically switches the controlled object to the main heater lamp 7 (HEAT SEL signal=0).

At a time of start (t1) of the heater alternate turn-on control, if the main heater detection temperature (main thermistor 10) is higher than the MAIN target temperature tmh and the sub-heater detection temperature (sub-thermistor 11) is lower than the SUB target temperature tsh, the engine control unit 9 even within the prescribed time Tmcp of the main heater lamp 7 (HEAT SEL signal=1). The engine control unit 4 outputs the SUB ON signal [1] to the driver 8, thereby turning on the sub-heater 9 (immediately after t1).

On the other hand, in the on-state of the sub-heater lamp 9, if the sub-heater detection temperature is equal to or higher than the SUB target temperature tsh and the main heater detection temperature is lower than the MAIN target temperature tmh, the engine control unit 4 immediately switches the controlled object to the main heater lamp 7 even where the prescribed time Tscp of the sub-heater lamp 9 is not reached (HEAT SEL signal=0).

In the on-state of the main heater lamp 7, even when the main heater detection temperature is lower than the MAIN target temperature tmh and the continuous turn-on time is less than the prescribed time Tmcp, if the sub-heater detection temperature becomes lower than the SUB lower-limit temperature tsl (t2), the engine control unit 4 immediately switches the controlled object to the sub-heater lamp 9 (HEAT SEL signal=1).

In the on-state of the sub-heater lamp 9, even when the sub-heater detection temperature is the sub-heater target temperature tsh and the continuous turn-on time is less than the prescribed time Tscp, the main heater lower-limit temperature tml, the engine control unit 4 immediately switches the controlled object to the main heater lamp 7 (HEAT SEL signal=0).

During the printing operation, if the main heater detection temperature decreases to the main heater lower-limit temperature tml and the sub-heater detection temperature decreases to the sub-heater lower-limit temperature tsl (t3), the engine control unit 4 informs the main CPU 1 of a low-temperature error. Upon receiving the low-temperature error, the main CPU 1 temporarily halts the printing operation and sets the Warm UP signal [1] in the engine control unit 4. If the warm-up is executed and the apparatus is set in the print-enable state (t4), the main CPU 1 sets the Warm UP signal at [0].

If the main heater detection temperature rises to the main heater abnormal temperature tmerr or the sub-heater detection temperature rises to the sub-heater abnormal temperature tserr (t5 or t6), the engine control unit 4 determines occurrence of an abnormal high-temperature state, forcibly turns off the heater control and informs the main CPU 1 of the abnormal high temperature. Upon receiving the information about the abnormal high temperature, the main CPU 1 executes an error process.

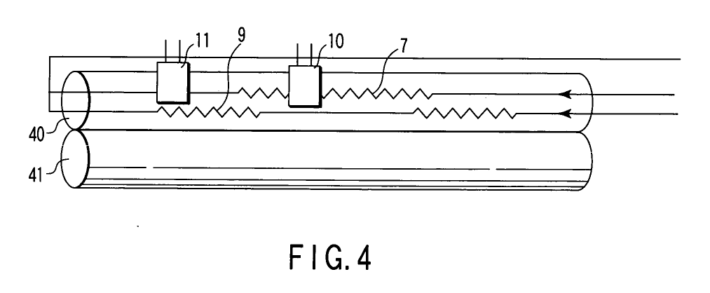

FIG. 4 shows a modification of the fixing roller, wherein the heater lamp is divided and disposed at a central part (main heater lamp) and both side parts (sub-heater lamp) of a single heat roller. This modification of the fixing roller, as shown in FIG. 4, comprises a heat roller 40 and a pressure-contact roller 41. The heat roller 40 includes a main heater lamp 7 and a sub-heater lamp 9. A main thermistor 10 is provided at the central part of the heat roller 40, and a sub-thermistor 11 is provided at an end part of the heat roller 40.

In this structure, too, the above-described temperature control is effective.

The main heater lamp 7 shown in FIG. 2 may be dividedly provided at the central and side parts, as shown in FIG. 4. In this case, the sub-heater lamp 9 shown in FIG. 2 and both side end parts of the main heater lamp 7 are controlled as a single-set sub-heater. The temperatures are independently controlled.

As has been described above, according to the embodiment of the present invention, the warm-up operation by the simultaneous turn-on of the main heater lamp and sub-heater lamp can be executed at higher speed, and the power during the printing operation can be averaged by the divisional turn-on.

Furthermore, more suitable power averaging can be realized by switching the controlled object on the basis of time and temperatures.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus including a fixing device composed of a first heat roller that is heated by a first heater lamp and a second heat roller that is heated by a second heater lamp, the apparatus comprising:
first detection means for detecting a surface temperature of the first heat roller;
second detection means for detecting a surface temperature of the second heat roller; and
control means for effecting a control to execute simultaneous turn-on of the first and second heater lamps at time of a warm-up operation, to execute alternate turn-on of the first and second heater lamps for a prescribed time at a time of an image forming operation and at a time of a standby operation, and to execute switching of the turned-on heater lamp to the first heater lamp or the second heater lamp even within the prescribed time, in a case where during the alternate turn-on, a detection temperature by the first or second detection means of the first or second heat roller due to heating of the turned-on first or second heater lamp is equal to or higher than a target temperature and a detection temperature by the first or second detection means of the first or second heat roller due to the turned-off first or second heater lamp is equal to or lower than a target temperature.

2. The image forming apparatus according to claim 1, wherein the control means immediately executes switching of the turned-on heater lamp to the first heater lamp or the second heater lamp, in a case where during the alternate turn-on, a detection temperature by the first or second detection means of the first or second heat roller due to heating of the turned-on first or second heater lamp is equal to or lower than the target temperature within the prescribed time and a detection temperature by the first or second detection means of the first or second heat roller due to the turned-off first or second heater lamp is equal to or lower than a lower-limit set temperature.

3. The image forming apparatus according to claim 1, wherein the prescribed time that is controlled by the control means is set to be a time enough to reach the target temperature from a preset lower-limit temperature, in a printing operation using ordinary paper in a normal environment.

4. The image forming apparatus according to claim 1, wherein the control means temporarily halts the image forming operation and executes a control for the warm-up operation, in a case where during the alternate turn-on in the image forming operation, detection temperatures by the first and second detection means are both lower than lower-limit set temperatures.

5. An image forming apparatus including a fixing device composed of a heat roller that is heated by a first heater lamp and a second heater lamp, the apparatus comprising:
first detection means for detecting a surface temperature of the heat roller at a time the heat roller is heated by the first heater lamp;
second detection means for detecting a surface temperature of the heat roller at a time the heat roller is heated by the second heater lamp; and
control means for effecting a control to execute simultaneous turn-on of the first and second heater lamps at time of a warm-up operation, to execute alternate turn-on of the first and second heater lamps for a prescribed time at a time of an image forming operation and at a time of a standby operation, and to execute switching of the turned-on heater lamp to the first heater lamp or the second heater lamp even within the prescribed time, in a case where during the alternate turn-on, a detection temperature by the first or second detection means of the heat roller due to heating of the turned-on first or second heater lamp is equal to or higher than a target temperature and a detection temperature by the first or second detection means of the heat roller due to the turned-off first or second heater lamp is equal to or lower than a target temperature.

6. The image forming apparatus according to claim 5, wherein the control means immediately executes switching of the turned-on heater lamp to the first heater lamp or the second heater lamp, in a case where during the alternate turn-on, a detection temperature by the first or second detection means of the heat roller due to heating of the turned-on first or second heater lamp is equal to or lower than the target temperature within the prescribed time and a detection temperature by the first or second detection means of the heat roller due to the turned-off first or second heater lamp is equal to or lower than a lower-limit set temperature.

7. The image forming apparatus according to claim 5, wherein the prescribed time that is controlled by the control means is set to be a time enough to reach the target temperature from a preset lower-limit temperature, in a printing operation using ordinary paper in a normal environment.

8. The image forming apparatus according to claim 5, wherein the control means temporarily halts the image forming operation and executes a control for the warm-up operation, in a case where during the alternate turn-on in the image forming operation, detection temperatures by the first and second detection means are both lower than lower-limit set temperatures.

9. An image forming apparatus including a fixing device composed of a first heat roller that is heated by a main heater lamp and a sub-heater lamp and a second heat roller that is heated by a second heater lamp, the apparatus comprising:
first detection means for detecting a surface temperature of the first heat roller at a time the first heat roller is heated by the main heater lamp;
second detection means for detecting a surface temperature of the second heat roller at a time the second heat roller is heated by the second heater lamp; and
control means for effecting a control to execute simultaneous turn-on of the main heater lamp, the sub-heater lamp and the second heater lamp at time of a warm-up operation, to execute alternate turn-on of the main heater lamp, and the sub-heater lamp and the second heater lamp for a prescribed time at a time of an image forming operation and at a time of a standby operation, and to execute switching of the turned-on heater lamp to the first heater lamp or the second heater lamp even within the prescribed time, in a case where during the alternate turn-on, a detection temperature by the first or second detection means of the first or second heat roller due to heating of the turned-on main heater lamp or heating of the turned-on sub-heater lamp and second heater lamp is equal to or higher than a target temperature and a detection temperature by the first or second detection means of the first or second heat roller due to the turned-off main heater lamp or the turned-off sub-heater lamp and second heater lamp is equal to or lower than a target temperature.

10. The image forming apparatus according to claim 9, wherein the control means immediately executes switching of the turned-on heater lamp to the main heater lamp or the sub-heater lamp and second heater lamp, in a case where during the alternate turn-on, a detection temperature by the first or second detection means of the first or second heat roller due to heating of the turned-on main heater lamp or heating of the turned-on sub-heater lamp and second heater lamp is equal to or lower than the target temperature within the prescribed time and a detection temperature by the first or second detection means of the first or second heat roller due to the turned-off main heater lamp or the turned-off sub-heater lamp and second heater lamp is equal to or lower than a lower-limit set temperature.

11. A temperature control method for a fixing device composed of a first heat roller that is heated by a first heater lamp and a second heat roller that is heated by a second heater lamp, comprising:
detecting a surface temperature of the first heat roller;
detecting a surface temperature of the second heat roller;
executing simultaneous turn-on of the first and second heater lamps at time of a warm-up operation;
executing alternate turn-on of the first and second heater lamps for a prescribed time at a time of an image forming operation and at a time of a standby operation; and
executing switching of the turned-on heater lamp to the first heater lamp or the second heater lamp even within the prescribed time, in a case where during the alternate turn-on, the detected surface temperature of the first or second heat roller due to heating of the turned-on first or second heater lamp is equal to or higher than a target temperature and the detected surface temperature of the first or second heat roller due to the turned-off first or second heater lamp is equal to or lower than a target temperature.

12. The temperature control method for a fixing device, according to claim 11, wherein switching of the turned-on heater lamp is immediately executed to the first heater lamp or the second heater lamp, in a case where during the alternate turn-on, the detected surface temperature of the first or second heat roller due to heating of the turned-on first or second heater lamp is equal to or lower than the target temperature within the prescribed time and the detected surface temperature of the first or second heat roller due to the turned-off first or second heater lamp is equal to or lower than a lower-limit set temperature.

13. The temperature control method for a fixing device, according to claim 11, wherein the prescribed time is set to be a time enough to reach the target temperature from a preset lower-limit temperature, in a printing operation using ordinary paper in a normal environment.

14. The temperature control method for a fixing device, according to claim 11, wherein the image forming operation is temporarily halted and a control for the warm-up operation is executed in a case where during the alternate turn-on in the image forming operation, the detected surface temperatures of the first and second heat rollers are both lower than lower-limit set temperatures.

15. A temperature control method for a fixing device composed of a heat roller that is heated by a first heater lamp and a second heater lamp, comprising:
detecting a surface temperature of the heat roller at a time the heat roller is heated by the first heater lamp;
detecting a surface temperature of the heat roller at a time the heat roller is heated by the second heater lamp;
executing simultaneous turn-on of the first and second heater lamps at time of a warm-up operation;
executing alternate turn-on of the first and second heater lamps for a prescribed time at a time of an image forming operation and at a time of a standby operation; and
executing switching of the turned-on heater lamp to the first heater lamp or the second heater lamp even within the prescribed time, in a case where during the alternate turn-on, the detected surface temperature of the heat roller due to heating of the turned-on first or second heater lamp is equal to or higher than a target temperature and the detected surface temperature of the heat roller due to the turned-off first or second heater lamp is equal to or lower than a target temperature.

16. The temperature control method for a fixing device, according to claim 15, wherein switching of the turned-on heater lamp is immediately executed to the first heater lamp or the second heater lamp, in a case where during the alternate turn-on, the detected surface temperature of the heat roller due to heating of the turned-on first or second heater lamp is equal to or lower than the target temperature within the prescribed time and the detected surface temperature of the heat roller due to the turned-off first or second heater lamp is equal to or lower than a lower-limit set temperature.

17. The temperature control method for a fixing device, according to claim 15, wherein the prescribed time is set to be a time enough to reach the target temperature from a preset lower-limit temperature, in a printing operation using ordinary paper in a normal environment.

18. The temperature control method for a fixing device, according to claim 15, wherein the image forming operation is temporarily halted and a control for the warm-up operation is executed in a case where during the alternate turn-on in the image forming operation, the detected surface temperature of the heat roller due to heating of the first heater lamp and the detected surface temperature of the heat roller due to heating of the second heat roller are both lower than lower-limit set temperatures.

19. A temperature control method for a fixing device composed of a first heat roller that is heated by a main heater lamp and a sub-heater lamp and a second heat roller that is heated by a second heater lamp, comprising:
detecting a surface temperature of the first heat roller at a time the first heat roller is heated by the main heater lamp;
detecting a surface temperature of the second heat roller at a time the second heat roller is heated by the second heater lamp;
executing simultaneous turn-on of the main heater lamp, the sub-heater lamp and the second heater lamp at time of a warm-up operation;
executing alternate turn-on of the main heater lamp, and the sub-heater lamp and the second heater lamp for a prescribed time at a time of an image forming operation and at a time of a standby operation; and
executing switching of the turned-on heater lamp to the main heater lamp and the sub-heater lamp or the second heater lamp even within the prescribed time, in a case where during the alternate turn-on, the detected surface temperature of the first or second heat roller due to heating of the turned-on main heater lamp or heating of the turned-on sub-heater lamp and second heater lamp is equal to or higher than a target temperature and the detected surface temperature of the first or second heat roller due to the turned-off main heater lamp or the turned-off sub-heater lamp and second heater lamp is equal to or lower than a target temperature.

20. The temperature control method for a fixing device, according to claim 19, wherein switching of the turned-on heater lamp is immediately executed to the main heater lamp or the sub-heater lamp and second heater lamp, in a case where during the alternate turn-on, the detected surface temperature of the first or second heat roller due to heating of the turned-on main heater lamp or heating of the turned-on sub-heater lamp and second heater lamp is equal to or lower than the target temperature within the prescribed time and the detected surface temperature of the first or second heat roller due to the turned-off main heater lamp or the turned-off sub-heater lamp and second heater lamp is equal to or lower than a lower-limit set temperature.
